(19) United States
(12) Patent Application Publication
(10) Pub. No.: US 2001/0003718 A1
(43) Pub. Date: Jun. 14, 2001

(54) TRANSMISSION CHAIN

(75) Inventors: KOUICHI ICHIKAWA, SAITAMA-KEN (JP); NOBUTO KOZAKURA, SAITAMA-KEN (JP); TSUTOMU HAGINOYA, SAITAMA-KEN (JP); TOYONAGA SAITOU, SAITAMA-KEN (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: ARMSTRONG, WESTERMAN, HATTORI, McLELAND & NAUGHTON

(21) Appl. No.: 09/217,966

(22) Filed: Dec. 22, 1998

(30) Foreign Application Priority Data
Dec. 24, 1997 (JP) 355547/1997

(51) Int. Cl. F16G 13/02; F16G 13/04

(52) U.S. Cl. 474/229; 474/213; 474/207

(57) ABSTRACT

A transmission chain includes a plurality of cylindrical hollow bushes each of which has an outer circumferential surface press-fitted into a bush hole formed in at least one plate, as well as an inner circumferential surface rotatably supported by an outer circumferential surface of a pin. The at least one plate is arranged at such a position relative to a corresponding bush as to prevent a center portion of the bush from expanding radially outward even when the bush is press-fitted into the plate. Since deformation of a bush during press-insertion of the bush into the plates can be prevented and thus the parallelism of the inner circumferential surface of the bush is maintained, elongation of the chain which would otherwise occur due to wear at the initial stage of use of the chain is suppressed effectively.

### BACKGROUND OF THE INVENTION

1. Field of the Invention

The present invention relates to a transmission chain, such as a silent chain or a bushed chain, in which bushes are used.

2. Description of the Related Art

Conventionally, some transmission chains such as timing chains used in engines have utilized cylindrical hollow bushes rotatably fitted onto the outer circumferential surfaces of pins. In such a transmission chain, in the longitudinal direction of the chain there are alternately arranged a row of plates through which a pin is directly inserted without use of a bush, and a row of plates through which a pin is inserted with a bush interposed between the pin and the plates.

In the conventional transmission chain in which bushes are used, as shown in FIG. 5, two plates A are attached to opposite ends of a bush B during assembly of the chain such that the opposite ends of the bush B are press-fitted into bush holes formed in the plates A. Therefore, when the plates A are attached to the ends of the bush B, the bush B receives a n axial compression force, so that the center portion of the bush B tends to expand radially outward and the bush B assumes the shape of a barrel.

Consequently, the inner circumferential surface of the bush B does not achieve full surface contact with the outer circumferential surface of the pin C, with the result that only inner circumferential edge portions e at the opposite ends of the bush B come into contact with the outer circumferential surface of the pin C. Therefore, at the initial stage of use of the chain, the inner circumferential edge portions e and those portions of the outer circumferential surface of the pin C that are in contact with the edge portions undergo local wear. Especially, since wear of the inner circumferential edge portions e is considerable, the entire chain elongates to a large extent within a short period of time.

When such local wear proceeds and the bush B and the pin C start to establish full surface contact therebetween, the elongation of the chain stops substantially. However, such elongation at the initial stage of use of the chain increases noise generated due to meshing engagement between the chain and sprockets, and often causes skipping of teeth.

Especially, when a chain having bushes is used as a timing chain for transmitting rotation of the crankshaft of an engine to the camshaft thereof, elongation of the chain results in out-of-sync drive timing of the camshaft, which causes considerable adverse effects.

### SUMMARY OF THE INVENTION

An object of the present invention is to solve the above-mentioned problems involved in conventional transmission chains, and to provide a transmission chain which can prevent local wear of pins and bushes, thereby suppressing elongation of the chain at the initial stage of use.

To achieve the above object, the present invention provides a transmission chain having a plurality of cylindrical hollow bushes each of which has an outer circumferential surface press-fitted into a bush hole formed in at least one plate, as well as an inner circumferential surface rotatably supported by an outer circumferential surface of a pin. The at least one plate is arranged at such a position relative to a corresponding bush as to prevent a center portion of the bush from expanding radially outward even when the bush is press-fitted into the plate, thereby maintaining the parallelism of the inner circumferential surface of the bush.

In the transmission chain of the present invention, the center portion of a bush can be prevented from expanding radially outward in the shape of a barrel during assembly of the chain, which expansion would otherwise occur due to an axial compression force applied to the bush during the assembly. Therefore, from the initial stage of use of the chain, full surface contact can be established between the inner circumferential surface of the bush and the outer circumferential surface of a corresponding pin.

As a result, there can be prevented elongation of the chain at the initial stage of use of the chain which would otherwise occur due to local wear of pins and bushes. Therefore, there can be prevented, for a long period of time, an increase in noise generated due to meshing engagement between the chain and sprockets, as well as skipping of teeth. Further, the accuracy of the chain can be maintained for a long period of time.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a plan view of a transmission chain according to an embodiment of the present invention;

FIG. 2 is a side view of the transmission chain according to the embodiment of the present invention;

FIG. 3 is a sectional view showing a state in which plates are attached to a bush of the transmission chain according to the embodiment of the present invention;

FIGS. 4A and 4B are sectional views each showing a state in which a plate or plates are attached to a bush of a transmission chain according to another embodiment of the present invention;

FIG. 5 shows a state of contact between a pin and a bush in a conventional transmission chain; and

FIG. 6 is a graph showing the results of a test in which elongation of the transmission chain of the present invention was compared with that of a conventional transmission chain using bushes.

### DESCRIPTION OF THE PREFERRED EMBODIMENT

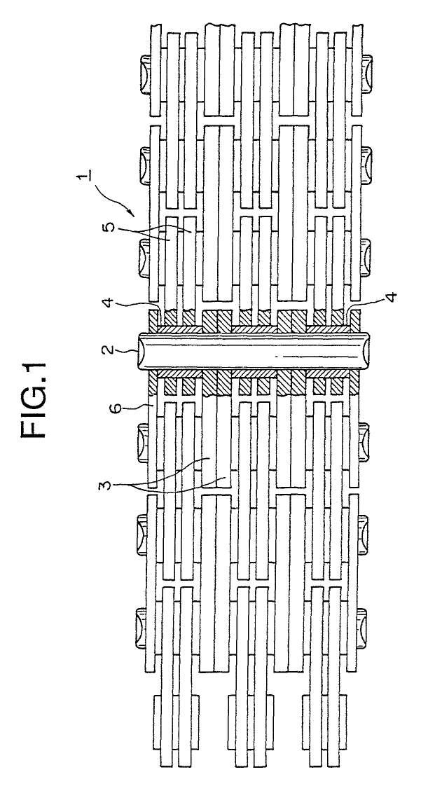

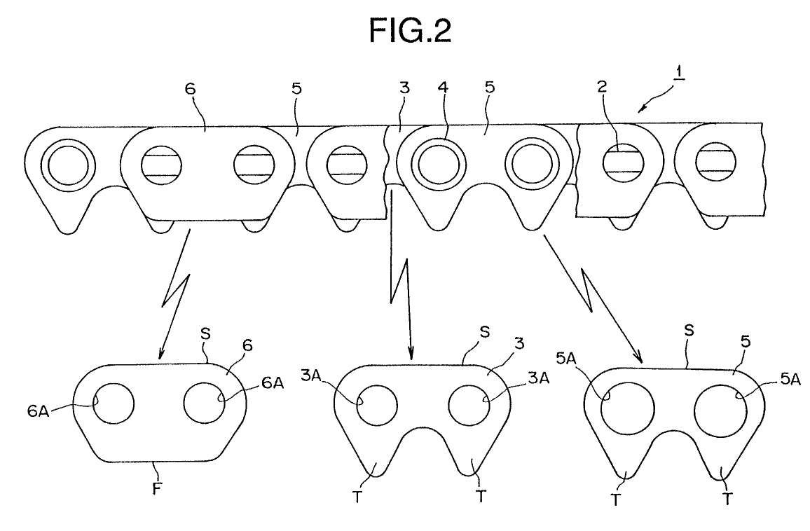

An embodiment of the present invention will next be described with reference to the drawings. A transmission chain according to the present embodiment is one type of a silent chain used as a timing chin for an engine. FIG. 1 shows a partial plan view of the transmission chain, and FIG. 2 shows a partial side view of the transmission chain.

As shown in FIGS. 1 and 2, a silent chain (hereinafter referred to as a “chain”) 1 includes guide-row plates 3, joint-row plates 5, and guide plates 6. Each of the guide-row plates 3 has a pair of pin holes 3A into which pins 2 are inserted. Each of the joint-row plates 5 has a pair of bush holes 5A into which bushes 4 are inserted. Each of the guide plates 6 has a pair of pin holes 6A into which the pins 2 are press-fitted to be fixed thereto.

Although not illustrated in FIGS. 1 and 2, the chain 1 is fitted around and extends between a driving sprocket attached to a crankshaft of an engine and a driven sprocket attached to a camshaft of the engine, in order to transmit power between the shafts. Meshing teeth T for achieving meshing engagement with these sprockets are formed at sides of the guide-row plates 3 and the joint-row plates 5, which sides form an inner circumference of the chain 1.

At each side of the guide plates 6, which side forms the inner circumference of the chain 1, there are formed not meshing teeth but a straight edge portion F. In the vicinity of the edge portion F, the inner surface of the guide plate 6 comes into contact with side surfaces of meshing teeth of the sprockets to be guided thereby.

In the chain 1 of the present embodiment, three bushes 4 are rotatably supported on a single pin 2. Two guide-row plates 3, which are in close contact with each other, are sandwiched between two adjacent bushes 4. The opposite end portions of the pin 2 are securely fitted into and thereby fixed to the pin holes 6A of the guide plates 6 disposed on opposite transversal sides of the chain 1.

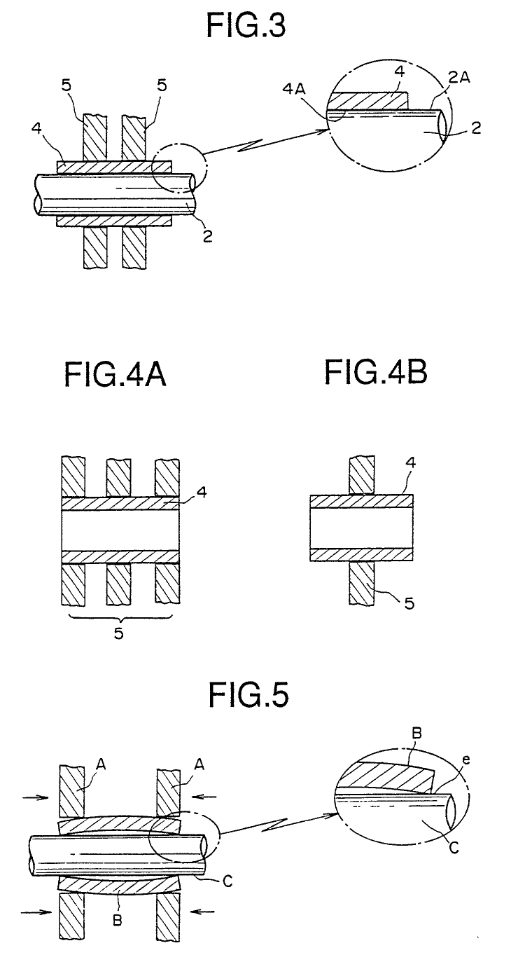

FIG. 3 shows a state in which the joint-row plates 5 are attached to the bush 4 in the chain 1 shown in FIGS. 1 and 2. In this embodiment, two joint-row plates 5 are fitted onto and thereby fixed to a single bush 4.

These joint-row plates 5 are disposed at positions offset from the opposite end surfaces of the bush 4 toward the central portion thereof. When the bush 4 is inserted into one of the bush holes 5A (see FIG. 2) of the joint-row plates 5 during assembly of the chain 1, the joint-row plates 5 are disposed at positions offset from the opposite end surfaces of the bush 4, so that the joint-row plates 5 prevent radially outward expansion or deformation of the central portion of the bush 4, which would otherwise occur due to an axial compression force acting on the bush 4. As a result, the parallelism of the inner circumferential surface 4A of the bush 4 is maintained, and therefore full surface contact is established between the inner circumferential surface 4A of the bush 4 and the outer circumferential surface 2A of the pin 2.

FIGS. 4A and 4B show other embodiments of the present invention, wherein FIG. 4A shows an embodiment in which three joint-row plates 5 are fitted onto a single bush 4 at opposite ends and the center portion thereof.

As in the embodiment shown in FIG. 3, in the embodiment shown in FIG. 4A, the joint-row plates 5—which are fitted onto the outer circumferential surface of the bush 4 at the center position thereof—revents the central portion of the bush 4 from expanding and deforming into the shape of a barrel, which expansion and deformation would otherwise occur during assembly. As a result, the parallelism of the inner circumferential surface 4A of the bush 4 is maintained after the attachment of the joint-row plates 5 onto the bush 4.

In the embodiment of FIG. 4B, two joint-row plates 5 that are provided at opposite ends of the bush 4 in the embodiment of FIG. 4A are omitted, so that a single joint-row plate 5 is disposed at a central position. The bush 4 used in the present embodiment is shorter than that used in the embodiment of FIG. 4A.

The number of the joint-row plates 5 fitted onto the bush 4 may be four or more, insofar as the joint-row plates 5 are disposed at such positions as to prevent deformation of the bush 4.

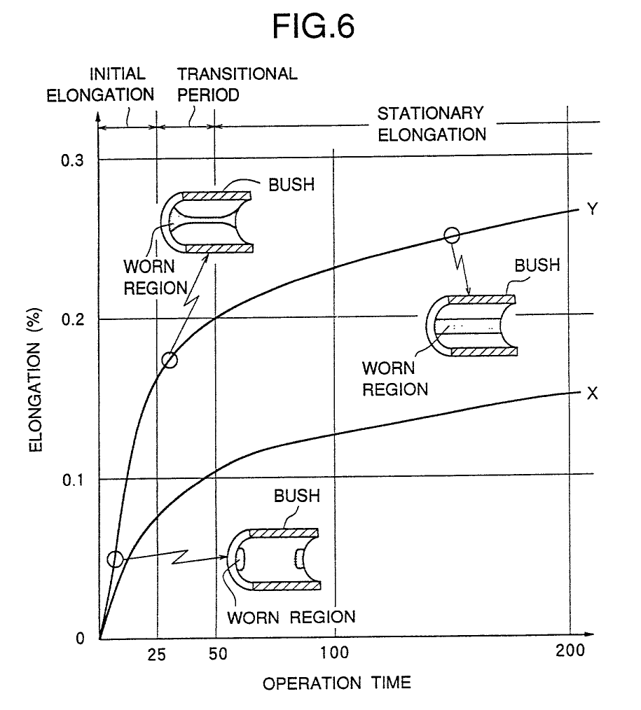

FIG. 6 is a graph showing the results of a test in which elongation of a transmission chain X of the present invention which has a plate arrangement shown in FIG. 3 is compared with that of a conventional transmission chain Y which uses bushes and has a plate arrangement shown in FIG. 5.

As shown in FIG. 6, the conventional transmission chain Y took 50 hours from the start of an operation to reach a stationary elongation. The initial elongation occurred within about 25 hours from the start of the operation, during which the chain Y elongated about 0.17%. At that time, local wear occurred in the inner circumferential surface of the bush in the vicinity of the opposite end of the bush where the bush was in contact with the pin.

Further, in the period of 25 hours to 50 hours during which the state of elongation changed from the initial elongation to the stationary elongation, the elongation of the transmission chain Y increased to a level of approximately 0.2%. During that period, the worn regions in the inner circumferential surface of the bush expanded axially inward from the opposite ends thereof and became continuous with each other at the center portion. Subsequently, the worn region became uniform in width along the axial direction of the inner circumferential surface of the bush, and the stationary elongation reached 0.25%.

By contrast, in the transmission chain X of the present invention, local wear did not occur, because the inner circumferential surface of the bush was in full surface contact with the pin from the start of the operation. The initial elongation occurring within about 25 hours from the start of the operation was about 0.08%, which is about half the initial elongation of the conventional transmission chain Y.

Further, in the period of 25 hours to 50 hours, the transmission chain Y elongated at a slower rate than did the conventional transmission chain Y. The stationary elongation after 50 hours had elapsed from the start of operation was considerably smaller than that of the conventional transmission chain Y.

In the above-described embodiments, a description is given of a silent chain which uses three kinds of plates; i.e., joint-row plates, guide-row plates, and guide plates. However, present invention is not limited to the silent chain and is similarly applicable to bushed chains in which bushes come into meshing engagement with sprockets.

Obviously, numerous modifications and variations of the present invention are possible in light of the above teachings. It is therefore to be understood that within the scope of the appended claims, the present invention may be practiced otherwise than as specifically described herein.

What is claimed is:

1. A transmission chain comprising a plurality of cylindrical hollow bushes, an outer circumferential surface of each bush being press-fitted into a bush hole formed in at least one plate, while an inner circumferential surface of each bush being rotatably supported by an outer circumferential surface of a corresponding pin, wherein
the at least one plate is arranged at such a position relative to a corresponding bush as to prevent a center portion of the bush from expanding radially outward even when the bush is press-fitted into the plate, thereby maintaining the parallelism of the inner circumferential surface of the bush.

2. A transmission chain according to claim 1, wherein a single plate is fitted onto a corresponding bush at a center portion of the bush in the axial direction.

3. A transmission chain according to claim 1, wherein two plates are fitted onto a corresponding bush at positions that are offset inward from opposite ends of the bush in the axial direction.

4. A transmission chain according to claim 1, wherein three plates are fitted onto a corresponding bush at opposite ends and a center portion of the bush in the axial direction.

5. A transmission chain comprising:
a plurality of joint-row plates each having a pair of bush holes;
a plurality of cylindrical hollow bushes, each bush being press-fitted into one of the bush holes of the joint-row plates; and
a plurality of pins, each pin being inserted into one of the bushes in order to rotatably support the corresponding bush, wherein
at least one joint-row plate is fitted onto each bush at such a position as to prevent a center portion of the bush from expanding radially outward even when the bush is press-fitted into the joint-row plate, thereby maintaining the parallelism of the inner circumferential surface of the bush.

6. A transmission chain according to claim 5, wherein a single joint-row plate is fitted onto each bush at a center portion of the bush in the axial direction.

7. A transmission chain according to claim 5, wherein two joint-row plates are fitted onto each bush at positions that are offset inward from opposite ends of the bush in the axial direction.

8. A transmission chain according to claim 5, wherein three joint-row plates are fitted onto each bush at opposite ends and a center portion of the bush in the axial direction.
